(19) United States
(12) Patent Application Publication
(10) Pub. No.: US 2018/0029198 A1
(43) Pub. Date: Feb. 1, 2018

(54) Rapid Assembly System

(71) Applicant: Christophe Boiteux, Landresse (FR)

(72) Inventor: Christophe Boiteux, Landresse (FR)

(21) Appl. No.: 15/552,753

(22) PCT Filed: Feb. 19, 2016
(86) PCT No.: PCT/FR2016/050391

§ 371 Date: Aug. 22, 2017

(30) Foreign Application Priority Data
Feb. 23, 2015 (FR) 1551521

(51) Int. Cl. B25B 5/14; B25B 5/06; B25B 5/02

(52) U.S. Cl. CPC B25B 5/145; B25B 5/02; B25B 5/061

(57) ABSTRACT

A rapid assembly system includes a mounting and a plate removably mounted onto the mounting. The system has connection devices between the plate and the mounting. Each device also includes a clamping means for holding the plate against the mounting; a tooth having a pair of tooth engagement surfaces arranged in a V-shape, the theoretical intersection of which extends in a tooth direction; and a groove with a pair of groove engagement surfaces for engaging the tooth engagement surfaces.

### BACKGROUND

The invention relates to a rapid assembly system in the industrial field, for example that of fixturing. The system comprises a mounting capable of removably receiving a plate.

It is known in the field of machining to provide plates on which parts to be machined are attached. The plates are then themselves flanged to the table or the spindle of a machining center to undergo machining operations. The advantage is that the parts can be interchanged very rapidly, which allows high productivity of the machining center. The parts are assembled to the plate during hidden time outside of the machining center. This solution also makes it possible to transfer the part to be machined between different stations without disassembling the part with respect to the plate and hence with respect to its frame of reference. Great accuracy it therefore assured between transfers to different stations.

Document DE 41 35 418 A1 proposes a plate of this type with its mounting. The plate and the mounting have a substantially square shape and are interlinked by four connection devices arranged at the four corners. Each connection device comprises a nipple attached to the plate and a cylinder attached to the mounting and designed to receive the nipple. A ball-based mechanism allows the locking of the nipple into the cylinder to be ensured. Centering is ensured by cylindrical centering surfaces centered on the axes of the nipple and of the cylinder and arranged on an upper diameter.

Such a system has the disadvantage of providing a largely hyperstatic positioning, which can cause assembly problems, in particular in an environment without temperature stabilization. Furthermore, attachment using balls creates single-point engagements which limit the forces that can be deployed.

The invention aims to supply an assembly system have strong capabilities in terms of load and having fewer positioning constraints.

### SUMMARY

With these objectives in view, the invention has as its object a rapid assembly system comprising a mounting and a plate assembled removably to the mounting, the system comprising at least two connection devices between the plate and the mounting, each device also comprising clamping means for holding the plate against the mounting, characterized in that each connection device comprises a tooth comprising a pair of tooth engagement surfaces arranged in a V shape, the theoretical intersection whereof extends in a tooth direction, and a groove comprising a pair of groove engagement surfaces for engaging the tooth engagement surfaces, the tooth directions of at least two different connection devices being oblique with respect to one another.

The system according to the invention allows having a plate that is rapidly removable. Its positioning is accomplished by guides which allow sliding in one direction. The positioning is therefore less constrained than in the prior art which did not allow displacement at each connection device. Moreover, as the engagement surfaces have a V shape, they do not allow any clearance to remain for loads in a plane perpendicular to the direction of the tooth. Complete positioning is also ensured thanks to the oblique orientation of at least two connection devices. The teeth can be positioned with perpendicular tooth directions in the case of two teeth, in a cross in the case of four teeth, or in a star in the case of three, five or more teeth. The tooth directions can be in the same plane or in different planes, parallel or not.

The system comprises for example at least three connection devices between the plate and the mounting.

According to one constructive arrangement, the teeth are carried by the mounting. The lower surface of the movable element, to with the plate, is thus large enough and ensures better stability of the plate when it is detached from the mounting and placed on this lower surface. Moreover, the engagement surface comprises only protruding elements and is thus more accessible for cleaning, so as to eliminate for example chips resulting from machining operations. However, the functions of mutually positioning elements would also be accomplished if the teeth were carried by the plate.

According to one constructive arrangement, the clamping means comprise at least one clamping device, each clamping device comprising at least one slide engaging, in the clamped position, against a groove clamping surface provided in the groove and inclined by 45° at the most with respect to the axis of the slide so as to press the tooth and groove engagement surfaces together. The clamping device is integrated completely into the tooth. The slide insures attachment not only by serving as an obstacle to the separation of the engagement surfaces, but also by accomplishing pressing of the engagement surfaces against one another. The inclination of the clamping surface determines an amplification of the sliding force of the slide, plus the inclination with respect to the axis of the side being low, the greater is the amplification. Moreover, there is near irreversibility, the reaction between the clamping surface no longer being capable of causing the retraction of the slide. The limit is a function of the possible travel of the slide and the risks of jamming the slide. Moreover, the engagements are those of plane surfaces against one another, which allows large forces to be transmitted without the risk of marking or deformation of surfaces.

In a complementary manner, the clamping device comprises a piston rod assembled sliding in the tooth in an oblique piston direction with respect to the axis of the slide, the piston rod cooperating through its end with the slide through deflection surfaces inclined with respect to the axes of the slide and the piston so that the sliding of the piston causes the sliding of the slide by mutually slipping the deflection surfaces. It is also possible to control the sliding of the slide by placing the rod parallel to the surfaces of the groove and thus limiting the width thereof. Moreover, the deflection surfaces can be inclined in such a manner as to also obtain an amplification of the force exerted by the piston rod and an increase in the irreversibility of the reaction.

According to other features:

the piston rod is actuated by elastic means tending to return the slide toward the clamping position: holding the clamping is thus ensured passively, without any other source of energy being available;

the elastic means are formed by at least one ring made of elastomers housed between a piston head attached to the piston rod and a closure plate firmly attached to the tooth; this solution allows a high actuating force with little use of space;

alternatively, the elastic means are formed by a stack of Belleville washers, between a piston head attached to the piston rod and a closure plate firmly attached to the tooth; the Belleville washers are washers the section whereof is flat but inclined with respect to the engagement plane of the washer; the stack can be any combination of alternating orientation of the washers;

the piston rod can be actuated by a fluid, against the elastic means, toward an open position; thus only unclamping requires the provision of external energy, for example in the form of compressed air or hydraulic fluid under pressure;

the deflection surfaces have a T shaped section so as to load the slide bi-directionally; the retraction of the slide can thus be controlled positively; the section could also be a dovetail or any other form of sliding ensuring bidirectional loading;

the clamping means comprise a second slide having the same axis as the first slide engaging, in the clamping position, against a second groove clamping surface provided in the groove and inclined by 45° at the most with respect to the axis of the slide so as to press the tooth and groove engagement surfaces together; a double clamping is then accomplished with one piston rod; moreover, the clamping is better distributed as is the loading of the piston rod;

each tooth comprises at least two clamping devices;

each tooth has a cylindrical body housed in a housing of the mounting;

the tooth is assembled pivotably in the housing; this allows self-alignment of the tooth along the direction of the groove; this possibility of pivoting can be limited.

### BRIEF DESCRIPTION OF THE DRAWINGS

The invention will be better understood and other peculiarities and advantages will appear upon reading the description that follows, the description making reference to the appended drawings wherein:

FIGS. 1 and 2 are views, respectively perspective and side, of a system conforming to a first embodiment of the invention;

FIGS. 3 through 5 are views, respectively side, top and perspective of a mounting forming a part of the system of FIG. 1;

FIG. 6 is a perspective view of the bottom of a plate forming part of the system of FIG. 1;

FIG. 7 is a perspective view of a tooth of the mounting of FIGS. 3 to 5;

FIG. 8 is a perspective view of a subassembly contained in the tooth of FIG. 7;

FIGS. 9 and 10 are section views of the tooth of FIG. 7, respectively in the clamping position and in the open position;

FIGS. 11 and 12 are similar views to those of FIGS. 9 and 10, more detailed and with the plate in place;

FIG. 13 is a perspective view of a mounting according to a second embodiment of the invention;

FIG. 14 is a section view of the mounting of FIG. 13;

FIG. 15 is a similar view to FIG. 13 of a system including the mounting and a plate;

FIG. 16 is a section view of the system of FIG. 15;

FIG. 17 is a perspective view of a clamping device of the plate of FIG. 13.

### DETAILED DESCRIPTION

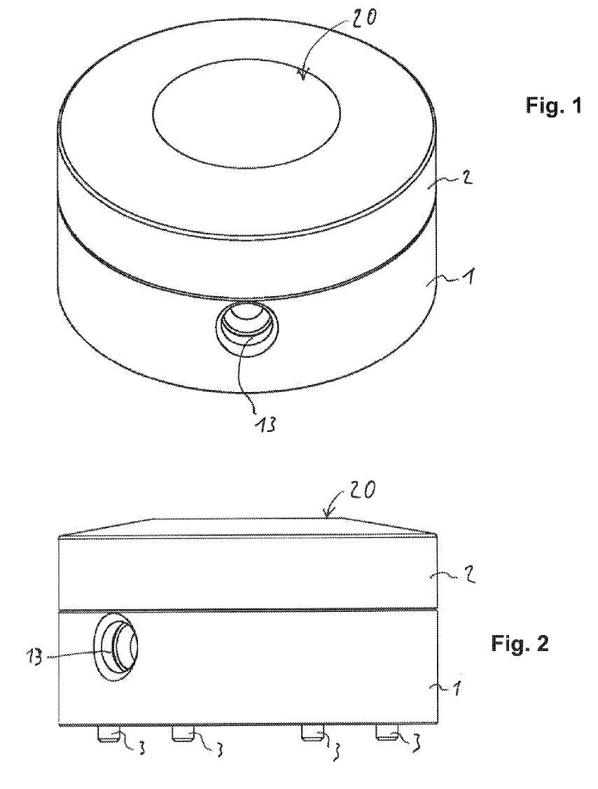

A rapid assembly system comprising a mounting 1 and a plate 2 assembled removably on the mounting 1 according to a first embodiment of the invention is shown in FIGS. 1 and 2. They have a cylindrical external shape of substantially the same diameter. The upper surface 20 of the plate 2 is intended to receive a part to be machined, not shown. The mounting 1 is designed to be assembled on a table or a spindle of a machine tool, not shown, such as a machining center or a lathe. Screws 3 are shown with the mounting 1 and are designed to attach it to the machine tool.

The assembly system comprises four connection devices 4 between the plate 2 and the mounting 1. Each connection device 4 comprises a tooth 41 attached to the mounting 1 and a groove 42 provided in the plate 2. Each tooth 41 comprises a pair of tooth engagement surfaces 411 arranged in a V shape, the theoretical intersection whereof extends in a tooth direction. The groove 42 comprises a pair of groove engagement surfaces 421 for engaging the tooth engagement surfaces 411 and therefore extends in the direction of the corresponding tooth 41. The four tooth directions form a cross at a right angle and are therefore in the same plane. The tooth engagement surfaces 411 thus form a chamfer on either side of the tooth 41 joined with a joining surface 12 of the mounting 1. Likewise, the groove engagement surfaces 421 form chamfers on the corners between the groove 42 and a lower surface 21 of the plate 2. When the plate 2 is assembled on the mounting 1, the teeth 41 are housed in the grooves 42, and there remains an interval between the joining surface 12 and the lower surface of the plate 2. The teeth 41 are separate parts which are assembled in housings 43 passing through the thickness of the mounting 1. The teeth 41 comprise heels at their base which come into abutment against the shoulders of the mounting 2, in the perimeter of the housings 43. A ring 22 is attached below the mounting 2 engaging with the teeth 41 so as to press them in engagement with the heels 412.

Clamping means 5 are provided for holding the plate 2 against the mounting 1. The clamping means 5 comprise two clamping devices 50, each clamping device 50 comprising two slides 501 with the same axis engaging, in the clamping position, against a respective groove clamping surface 51 provided in the groove 42 and inclined 30° with respect to the axis of the slide so as to press the tooth 411 and groove 421 engagement surfaces against one another. The clamping device 50 comprises a piston rod 502 mounted so as to slide in the tooth 41 in an oblique piston direction with respect to the axis of the slide. The piston rod 502 cooperates with its end with the slides 501 through deflection surfaces 503 inclined with respect to the axes of the slide and by 30° with respect to the axis of the piston so that the sliding of the piston rod causes sliding of the slides 501 in opposition by mutually sliding the deflection surfaces 503. The deflection surfaces 503 have a T shaped section so as to load the slides 501 bi-directionally.

The piston rod 502 receives a piston head 504 of greater size opposite to the deflection surfaces 503. The piston head 504 is assembled in a housing 505 so as to delimit a control chamber 506. The chamber 507 opposite to the control chamber 506 is occupied by elastic means which actuate the piston rod 502 by tending to return the slide 501 toward the clamping position. The elastic means are formed by two rings 508 made of elastomers housed in compression between the piston head 504 and a closure plate firmly attached to the tooth 41. The control chamber 506 is linked hydraulically to an inlet 13 so that the piston rod 502 can be actuated by a fluid against the elastic means 508 toward the open position.

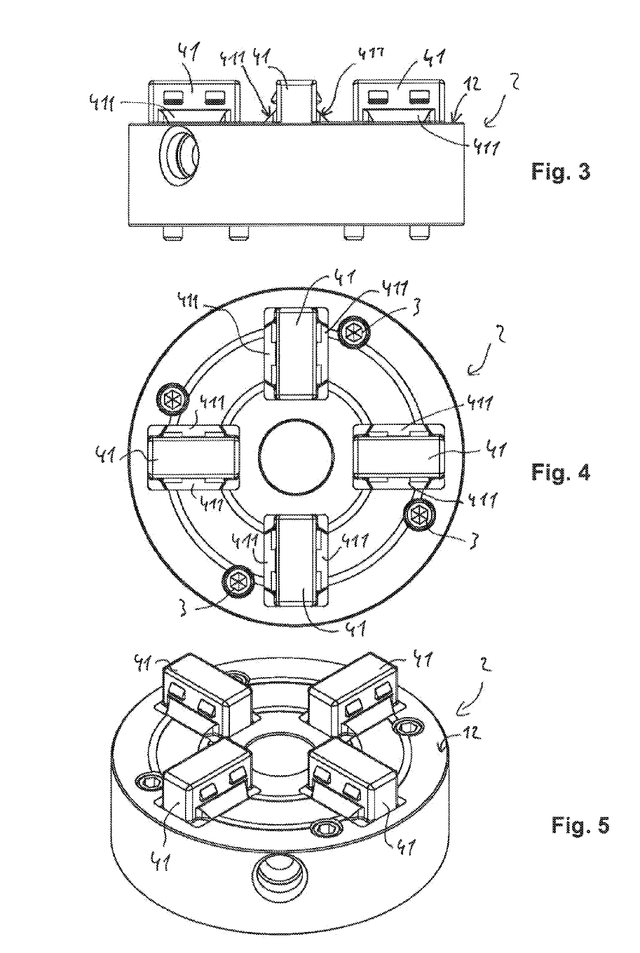

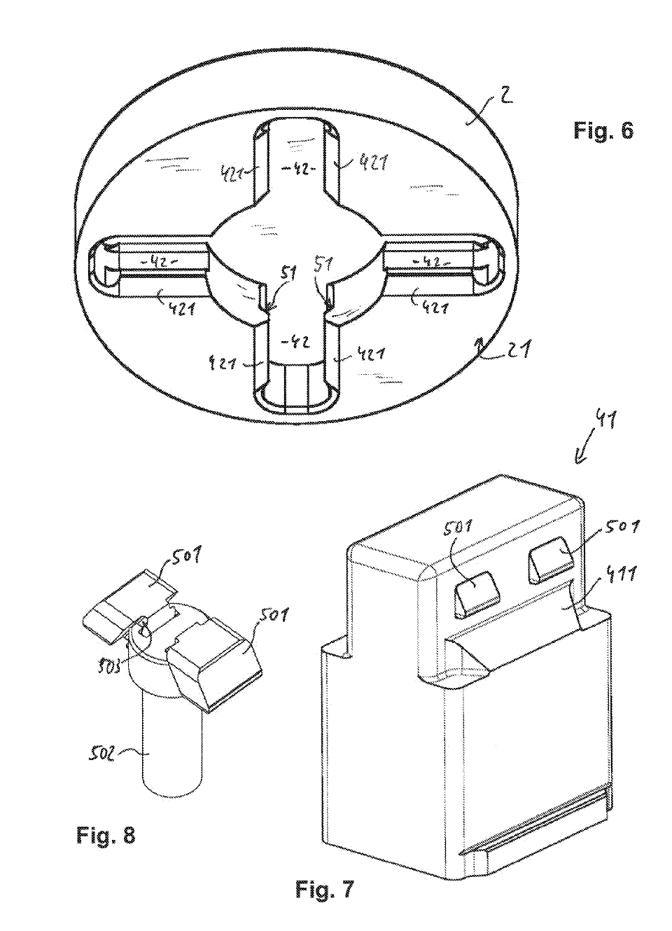

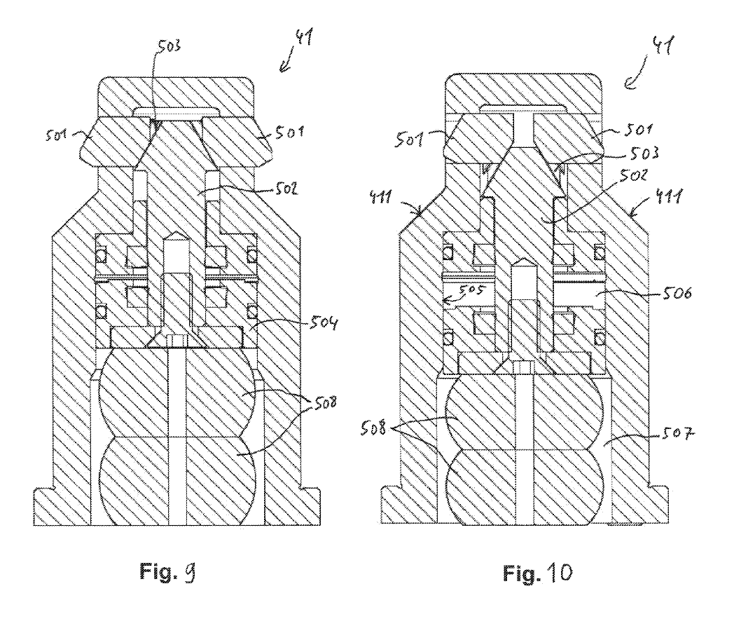

An initial position wherein the mounting 1 is separated from the plate 2 is considered, as shown in FIGS. 3 to 6.

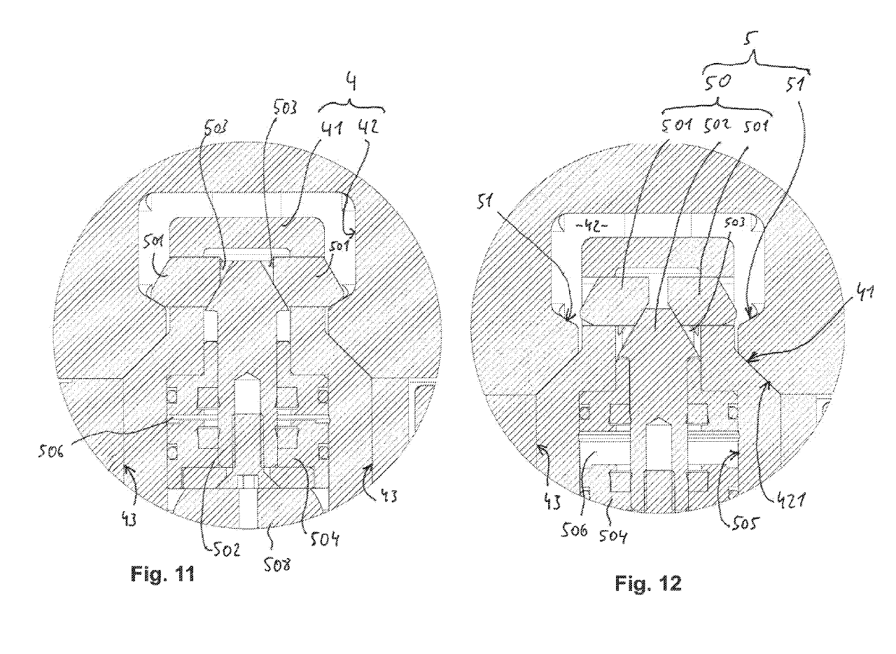

The open position is commanded by sending a fluid under pressure through the inlet into the control chambers 506. The piston rod 502 of the clamping devices 50 is displaced in the direction for compressing the rings 508. In this movement, the deflection surfaces 503 slide mutually to retract the slides 501, that is, move them closer to one another so that they almost do not protrude from the teeth 41, so as to attain the open position as shown in FIGS. 10 and 12.

The plate 2 can then be placed on the mounting 1 by inserting the teeth 41 into the grooves 42. The groove engagement surfaces 421 come into contact with the tooth engagement surfaces 411, which determines the position of the plate 2 with respect to the mounting 1. The pressure of the fluid is then released, and under the action of the elastic rings 508, the piston rod 502 is pressed back to reduce the volume of the control chamber 506. The piston rod 502 causes slipping of the deflection surfaces 503 so as to control the sliding of the slides 501 opposite to one another, to cause the teeth 41 to protrude. The slides 501 then come into engagement on the groove clamping surfaces 51. Due to their inclination, a plate 2 advancing force is generated on the engagement surfaces, thus ensuring the flanging of the plate 2 to the mounting 1.

For disassembly, pressurization of the control chambers is carried out again to obtain the retraction of the slides 501. The plate 2 is then released.

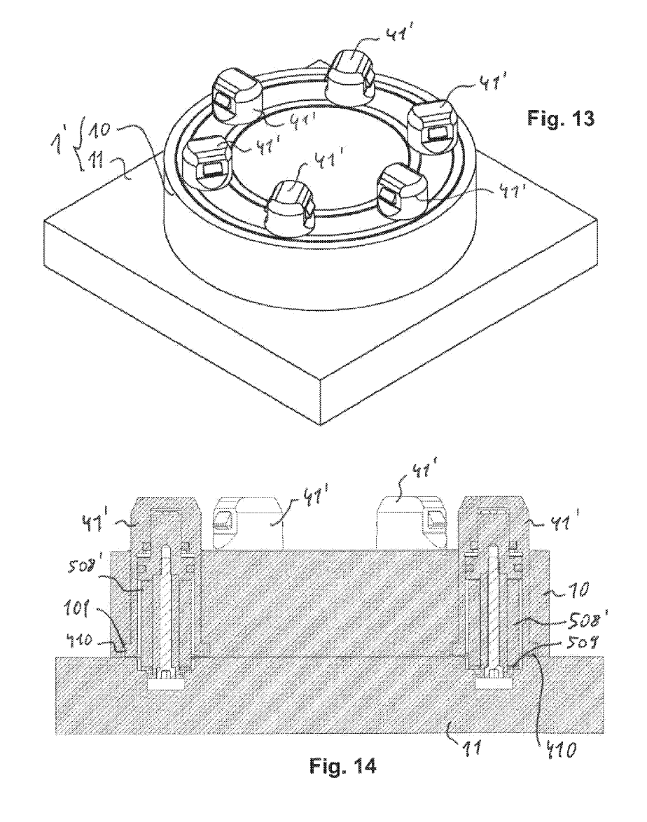

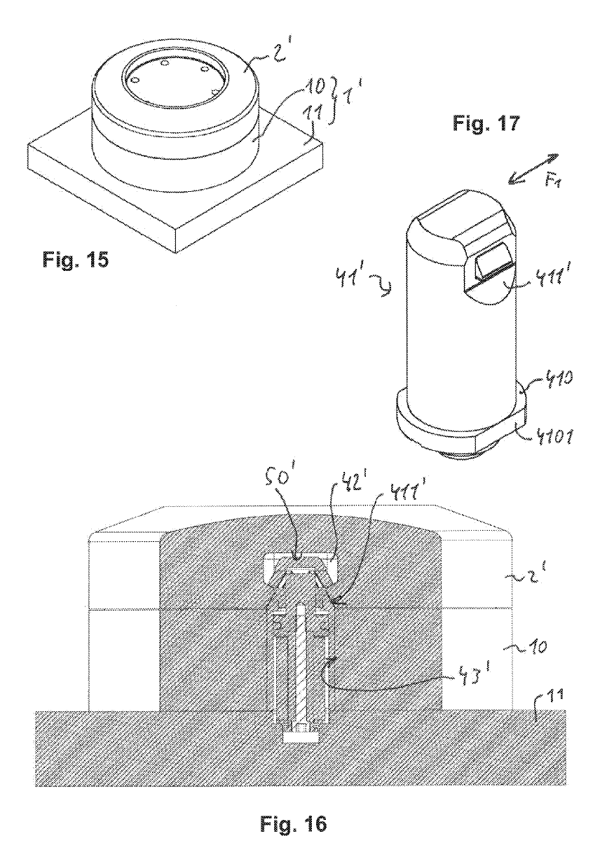

According to a second embodiment, shown in FIGS. 13 to 17, the teeth 41′ have a body with a cylindrical shape and are assembled into cylindrical housings 43′ of the plate 2′. The mounting 1′ comprises for example six teeth 41′ distributed around a center. The tooth engagement surfaces 411′ are oriented in such a manner that the tooth directions F1 converge at the center. Each tooth 41′ comprises a single clamping device 50′, similar to that described in connection with the first embodiment.

The mounting 1′ is formed of two parts, one upper part 10 bearing the housings 43′ of the teeth 41′, and a base plate 11 closing the housings 43′ to confine the teeth 41′ by enclosing a collar 410 at the base of the teeth 41′ in a rabbet 101 of the upper part 10. The elastic ring 508′ is engaged on the base plate 11 by means of a washer 509 to be placed under tension. The base plate 11 thus has the function of a closure plate as described with the first embodiment. The base plate 11 and the upper part 10 are assembled for example using screws, not shown. This assembly is also used for the first embodiment, though not visible in the figures.

In this embodiment, the collar 410 comprises two flats 4101 which cooperate with corresponding surfaces in the rabbet 101 so as to determine the orientation of the tooth 41′. As a variant, a considerable play can be provided so that the tooth 41′ is oriented in the direction of the groove 42′ of the plate 2′.

1.-15. (canceled)

16. A rapid assembly system comprising:
a mounting;
a plate removably assembled to the mounting,
at least two connection devices between the plate and the mounting, each connection device including a clamp for holding the plate against the mounting, and a tooth comprising (i) a pair of tooth engagement surfaces positioned in a V-shape such that a theoretical intersection extends in a tooth direction, and (ii) a groove comprising a pair of groove engagement surfaces for engaging the tooth engagement surfaces,
wherein the tooth directions of at least two different connection devices being oblique with respect to one another.

17. The assembly system according to claim 16, comprising at least three connection devices between the plate and the mounting.

18. The assembly system according to claim 16, wherein the teeth are carried by the mounting.

19. The assembly system according to claim 16, wherein the clamp comprises at least one clamping device, each comprising at least one slide engaging, in the clamped position, against a groove clamping surface provided in the groove and inclined at an angle with respect to the axis of the slide of no more than 45° wherein the tooth engagement surface contacts the groove engagement surface.

20. The assembly system according to claim 19, wherein the clamping device comprises a piston rod slidably positioned in the tooth in an oblique piston direction with respect to an axis of the slide, the piston rod having an end that cooperates with the slide through deflection surfaces inclined with respect to axes of the slide and the piston rod so that sliding of the piston causes sliding of the slide by mutually sliding the deflection surfaces.

21. The assembly system according to claim 20, further comprising a biasing member that acts to return the slide toward a clamping position.

22. The assembly system according to claim 21, wherein the biasing member includes at least one ring made of elastomers housed between a piston head attached to the piston rod and a closure plate attached to the tooth.

23. The assembly system according to claim 21, wherein the biasing member is formed by a stack of Belleville washers, between a piston head attached to the piston rod and a closure plate attached to the tooth.

24. The assembly system according to claim 21, wherein the piston rod can be actuated by a fluid against the biasing member toward an open position.

25. The assembly system according to claim 24, wherein the deflection surfaces have a T-shaped section so as to load the slide bi-directionally.

26. The assembly system according to claim 19, wherein the clamp comprises a second slide having an axis that is the same as the axis of first slide, and engaging, in the clamping position, against a second groove clamping surface provided in the groove and inclined with respect to the axis of the slide wherein the tooth engagement surface contacts the groove engagement surface.

27. The assembly system according to claim 26, wherein the inclination of the second groove clamping surface with respect to the axis of the slide is no more than 45°.

28. The assembly system according to claim 19, wherein each tooth comprises at least two clamping devices.

29. The assembly system according to claim 19, wherein each tooth has a cylindrical body housed in a housing of the mounting.

30. The assembly system according to claim 29, wherein the tooth is pivotably assembled in the housing.
